(19) United States
(12) Patent Application Publication
(10) Pub. No.: US 2026/0054691 A1
(43) Pub. Date: Feb. 26, 2026

(54) Technique for Controlling Access to a Motor Vehicle

(71) Applicant: Bayerische Motoren Werke Aktiengesellschaft, Muenchen (DE)

(72) Inventor: Matthias FINK, Muenchen (DE)

(21) Appl. No.: 19/300,758

(22) Filed: Aug. 15, 2025

(30) Foreign Application Priority Data
Aug. 23, 2024 (DE) 10 2024 124 208.6

(51) Int. Cl. B60R 25/24; H04L 9/40

(52) U.S. Cl. CPC B60R 25/24; H04L 63/0442; H04L 63/067; H04L 63/12; B60R 2325/205; H04L 2463/082

(57) ABSTRACT

A method for controlling access to a motor vehicle comprises receiving a shared vehicle key for a user of the motor vehicle, wherein the shared vehicle key is derived from a digital vehicle key for the motor vehicle; transmitting a verification message to verify that the shared vehicle key is stored on a mobile device of the user; receiving an authentication factor for activating the shared vehicle key; and accessing the motor vehicle by way of the shared key.

### CROSS REFERENCE TO RELATED APPLICATION

This application claims priority under 35 U.S.C. § 119 from German Patent Application No. DE 10 2024 124 208.6, filed Aug. 23, 2024, the entire disclosure of which is herein expressly incorporated by reference.

### BACKGROUND AND SUMMARY OF THE INVENTION

The invention relates to a method for controlling access to a motor vehicle, to a mobile device on which the method is implemented, and to a system comprising a motor vehicle and the mobile device.

A motor vehicle may be secured by way of a concept that has been proposed, by the Car Connectivity Consortium (CCC), as a digital car key (DCK). A comprehensive technical description may be found in the technical specification “Digital Key” (the current version of the specification at the time of writing of this document is “Release 3, Version 1.2.3”). The concept makes provision to control a security function of the motor vehicle, in particular a central locking system and/or an immobilizer, on the basis of an asymmetric cryptographic method. A user may be assigned a digital vehicle key in the form of a cryptographic data structure. A wireless connection between a mobile device and the motor vehicle is used to carry out authentication on the basis of this key.

By way of example, a digital vehicle key may comprise a private and a public part. The private part may be stored in a secure environment, for instance a trusted platform module (TPM) of a mobile device. Conversely, the motor vehicle is assigned a digital key the private part of which may be stored on board in a control device. A public part is known to a user. Two-way authentication is carried out on the basis of the respective private and public key parts in order to control a security or access function. If the authentication is successful, a requested security function is controlled on the motor vehicle, access to or use of the vehicle is enabled, etc.

A vehicle owner (this may also be a service provider such as for instance a car rental company, etc.) has the option of sharing their key; the shared or derived key allows a user (“friend”, for example a customer of the service provider) to use the motor vehicle. The method for sharing the key may for example, in accordance with the CCC, comprise transmitting a link or URL (Uniform Resource Locator) to the customer or user. This URL must be retrieved on the device on which the derived key is to be stored.

Key sharing among natural persons is normally based on trust, for example between family members or employees in a small business. In an impersonal or anonymous environment in which allocating a key to a person such as a customer, an employee of a large company, etc. is an administrative process, however, technical measures are required in order to establish trust. One problem that occurs in this case concerns the URL sent for the key sharing: This URL is generic per se, that is to say it is able to be retrieved from any device. By way of example, the authorized recipient of the URL is able to forward it to another device, unauthorized persons, etc., and/or the URL may be intercepted by a malicious party. There is a need to prevent such misuse by way of technical measures.

One object on which the present invention is based is that of providing an improved concept for a technique for controlling access to a motor vehicle. The invention achieves this object by means of the subjects of the independent claims. Preferred embodiments are specified in dependent claims.

A first aspect of forms of the present invention relate to a method for controlling access to a motor vehicle. Some forms of a method may be implemented by a user, for example on a mobile device. The method comprises receiving a shared, allocated or derived vehicle key, wherein the shared vehicle key is derived from a digital vehicle key for the motor vehicle. The method furthermore comprises transmitting a verification message to verify that the shared vehicle key is stored on a mobile device of the user. The method comprises, following transmission of the verification message, receiving an authentication factor for activation of the shared vehicle key. Finally, the method comprises accessing the motor vehicle by way of the shared vehicle key.

A second aspect of forms of the present invention relates to a further method for controlling access to a motor vehicle. By way of example, the method may be implemented on a server or in a backend. The method comprises transmitting a shared or derived vehicle key for a user of the motor vehicle, wherein the shared vehicle key is derived from a digital vehicle key for the motor vehicle. The method furthermore comprises receiving a verification message to verify that the shared vehicle key is stored on a mobile device of the user. The method furthermore comprises, in response to receiving the verification message, transmitting an authentication factor. Finally, the method comprises receiving an indication that the shared vehicle key has been activated based on entry of the authentication factor.

Embodiments of the invention provide a framework for technical measures in order to establish a relationship of trust between an administrative body that issues the shared vehicle key and a natural person, such as a user, customer, etc. In particular, embodiments according to the invention enable a verification that the shared or derived key is actually stored on the mobile device of the authorized user, that is to say for example a device that was used when the user registered with a service provider, etc.

In some embodiments of the first aspect of the invention, the method comprises creating the verification message based for example on the user having to enter a dedicated password for key sharing on the mobile device on which the derived key is to be received and stored securely, or based on the user identifying themselves to the mobile device, for instance by entering a device identifier (PIN, passphrase or password), using a fingerprint sensor, facial recognition, etc.

In these or other embodiments, the method may comprise creating the verification message based on an electronic or cryptographic device key, wherein the device key is stored securely in the mobile device. In some embodiments, the device key may be stored for instance on a dedicated processor chip, in a memory area of a secure processor and/or memory secured in some other way, that is to say in a “secure processor environment” or a “secure environment”, wherein “secure” should generally be understood to mean restricted access to stored data, for instance in the sense of “hide & protect” of cryptographic material stored in the secure environment.

Access is generally carried out in this case via interfaces (application programming interfaces, APIs), wherein applications, for example at the operating system level or higher, which do not have an API available to them, are not able to access the memory content stored in the secure environment. More specifically, certain data portions, such as for instance a public key portion, may be read via API, while other information, for example a secret key portion, cannot be read in this way. By way of example, key references (handles) may be used to request actions with a specific key externally via API, such as for example generating a signature over certain data using a device key.

By way of example, the secure environment may comprise an HSM (hardware security module), TPM, a secure enclave, a TEE (trusted execution environment) and/or a secure element, etc., but may also comprise a specific product or multiple specific products that will be developed only in the future. For reasons of clarity, the terms “secure environment” and “secure element” will sometimes also be used synonymously herein, for example to indicate that a shared vehicle key is stored in one secure environment and a device key is stored separately in another secure environment. A “secure environment” may also designate a hardware environment, or else simply a software environment, firmware environment, combinations thereof, etc.

If a device key, as described above, is used to create the verification message, the recipient may assume, that is to say trust, that the verification message has been transmitted from the mobile device on which the shared key has been stored or is to be stored.

In some of the abovementioned embodiments, the method comprises the preliminary step of transmitting a registration message based on the device key. Accordingly, some embodiments of the second aspect of the invention may comprise receiving a registration message based on a device key that is stored in a secure environment of the mobile device, and may comprise storing the device key in association with a profile of the user. A registration procedure may comprise multiple steps. In some embodiments, the registration procedure comprises, beforehand, generating the device key, which may then for example be used to sign the registration message.

If a user is registered based on the device key, the mobile device used at registration is thus known to a service provider, etc. with which the registration takes place. This may be used for verification in the allocation process that the allocated key is actually stored on the mobile device of the user. In some embodiments, the derived key may for example be terminated if the verification fails.

In some embodiments according to the invention, the registration message may be sent in the course of registration of the user with a service provider. The service provider may for example store a public key portion, a certificate, etc. of the device key in association with a profile of the user. The subsequently received verification message is thus able to be checked with regard to whether it was created on the basis of the device key that was used on the mobile device of the user that was used at registration. Based on this, it is possible to construct methods for obtaining the shared key that for example do not require any time-consuming entry of a PIN, any facial recognition, etc. Such methods are convenient for the user, while at the same time ensuring that the shared key is stored on the authorized mobile device, that is to say has not been forwarded or intercepted by a third party, etc.

Some embodiments comprise signing a request message with the device key, and transmitting the request message to request the shared key used to initiate the actual allocation process. Accordingly, the service provider may transmit the allocated key to the sender of the request message. This makes it easy to ensure that the allocated key transmitted in response to the request message is transmitted to the mobile device of the authorized user that they used to register.

In some embodiments of the first aspect of the invention, the derived key may already grant access rights in the form of access or entry to the motor vehicle before receipt of the authentication factor, that is to say opening or unlocking of a (central) locking system, wherein the access rights however do not permit starting of a drive motor, driving, etc. of the motor vehicle. This is a prerequisite for certain further embodiments of methods according to the invention that require the user to carry out operational actions on a console of the vehicle, such as for instance entering a PIN (personal identification number), identifier, etc.

In some embodiments of the first aspect of the invention, the authentication factor may be a factor of multi-factor authentication (MFA), for example a second factor of two-factor authentication (2FA). The factor may for example comprise a character string, PIN, transaction number, one-time password, etc. to be entered in the vehicle.

In some embodiments, the allocated key might not grant any access rights whatsoever to the motor vehicle upon receipt, that is to say also not grant entry to the vehicle. In some of these embodiments, for example, in the event of successful verification, for example in parallel with the receipt of the authentication factor, an access right may grant access to the vehicle. Such embodiments provide the greatest possible security against misuse of allocated keys.

In certain embodiments of the first aspect of the invention, the method furthermore comprises receiving one-time information; signing the one-time information with the derived key and the device key; and creating and transmitting the verification message based on the signed one-time information. The one-time information (nonce) may be transmitted for example from a backend of the vehicle, a key management entity, etc. to the mobile device to which the allocated key has been transmitted. This process enables, in a simple and reliable manner, verification that the derived key is stored on the authorized mobile device.

A further aspect of the present invention relates to a mobile device designed to control access to a motor vehicle in accordance with a method described herein. The mobile device may in particular comprise a secure environment and/or a secure element for storing a device key and/or an allocated key. Software, an application, etc. may be installed on the mobile device, allowing the user to control a key allocation process, a preliminary registration process, etc. on the device.

Yet a further aspect of the present invention relates to a server, for instance in a backend for the vehicle, designed to control access to a motor vehicle in accordance with one of the methods described herein. The server may also be multiple servers, a server landscape, etc. By way of example, the server may be operated by a service provider and/or a manufacturer of the vehicle. Software may be installed on the server, allowing the provider to carry out service-related or administrative control of a key allocation process, a preliminary registration process, etc.

Yet a further aspect of the present invention relates to a system for controlling access to a motor vehicle. The system comprises the motor vehicle, a mobile device described herein, and a backend server described herein. The vehicle may be designed to store an allocated key, and to allow a user to enter an authentication factor and to forward this to the backend server.

Implementations of the invention will now be described in more detail with reference to the attached drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system;

FIG. 2A illustrates a flowchart of a first method;

FIG. 2B illustrates a flowchart of a second method;

FIG. 3A illustrates a flowchart of a third method; and

FIG. 3B illustrates a flowchart of a fourth method.

### DETAILED DESCRIPTION OF THE DRAWINGS

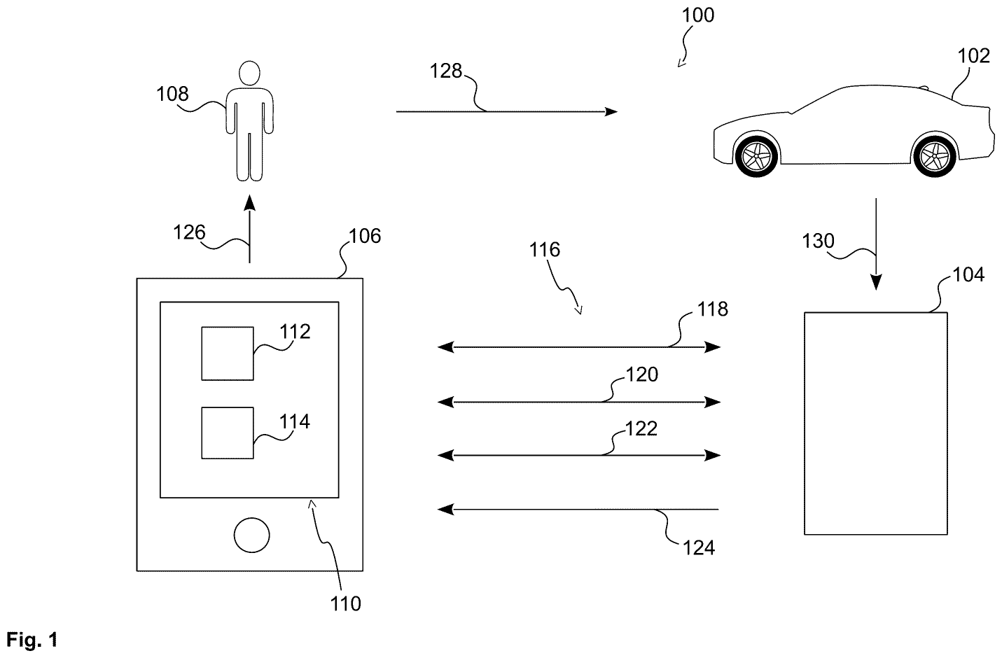

FIG. 1 schematically shows a system 100 comprising a motor vehicle 102, a server 104 in a backend for the vehicle 102, and a mobile device 106 of a user 108. The reference sign “104” is used hereinafter both to designate a or the backend 104 for the vehicle 102 in general and to designate specifically the server 104, wherein the server 104 may also be a plurality of interconnected servers, for example a server of a service provider such as for example an administrative owner or operator of the vehicle 102 (wherein the vehicle 102 may for instance belong to a vehicle fleet), a server of a manufacturer of the vehicle 102 (for example for a key management entity), a server of a manufacturer of the mobile device 106, etc.

The mobile device 106 has at least one secure environment 110, which may for example comprise a secure enclave and/or a secure element. An electronic or cryptographic device key 112 may in particular be or have been stored in the secure environment 110, along with a cryptographic or digital vehicle key, in particular a shared, allocated or derived vehicle key 114 for accessing the vehicle 102. Purely for the sake of clarity, mention will sometimes be made herein not to a “shared vehicle key”, but rather just to a “shared key” for short.

The mobile device 106 furthermore comprises interfaces (not illustrated) between the secure environment 110 and an operating system of the mobile device 106, along with interfaces between the operating system and other applications on the mobile device 106, for example an application (app) of a manufacturer of the vehicle 102, an app of a service provider operating the vehicle 102, etc. These one or more apps allow the user 108 to control a wide variety of functionalities of the vehicle 102, including accessing the vehicle 102, using the mobile device 106 on which the shared vehicle key 114 is stored.

In one exemplary embodiment in the CCC context, for instance, a vehicle access functionality and a driving functionality may be handled natively in the mobile device 106. For instance, the shared vehicle key 114 may thus be stored in a secure element, and a wireless radio standard such as for instance NFC (Near Field Communication) may for example have a direct channel into the secure element. This functionality may also even be present if the mobile device 106 is for instance in a state with a low battery, in which an operating system and other applications of the mobile device 106 are no longer operated normally.

According to various exemplary embodiments, the vehicle 102 is made available to the user 108 by a service provider in the context of car sharing, as a rental vehicle, etc., or an employer of the user 108 provides the vehicle 102 to its employees as part of a vehicle fleet. The user 108 receives access to the vehicle 102 by way of the allocated vehicle key 114, wherein the allocated key 114 has to be stored on the mobile device 108 of the user. The digital vehicle key (owner) of the vehicle 102 itself may for example be stored in the backend server 104.

A method for sharing a digital vehicle key, that is to say for creating a derived key and storing the derived key on a mobile device of the (co-)user, may be based on trust, for example on personal acquaintance, family affiliation, affiliation with a small company, etc. In this case, the sharing generally takes place between the mobile devices of the vehicle owner and the co-user. In the case of other, less personal relationships, a derived vehicle key may be allocated by the backend 104 to a mobile device 106, for example in the case of corresponding commercial business models (business-to-business, B2B, or business-to-consumer, B2C), but also for example for a breakdown service, a valet parking service or vehicle parking service, etc.

In general, multiple operators may be involved in the key allocation in the background or in the backend 104, for example a service provider regarding the abovementioned business models, a separate key management provider, etc.

A B2B or B2C service provider in the backend 104 requires information about the authorized user 108 in order to be able to allocate a derived key 114 thereto, to be able to decide which vehicle should be allocated to the user 108, etc. Such information may be collected in a process of registering the user 108 with the service provider, in a booking process for the vehicle 102, etc. In general, key allocation may be initiated by an administrator or by the user 108.

During the allocation process, the user 108 will receive a link or URL on their mobile device 106. In principle, the user 108 could forward the received URL, for example to another, separate mobile device, to the mobile device of another, unauthorized user, or the URL is forwarded (maliciously) without the user 108 noticing. According to the invention, technical precautions are proposed that ensure that the allocated key 114 provides only the authorized user 108 with access to the vehicle 102. More specifically, it is ensured that the allocated key 114 is or has been stored on the mobile device 106 of the user 108, otherwise the key 114 does not grant access rights to the vehicle 102.

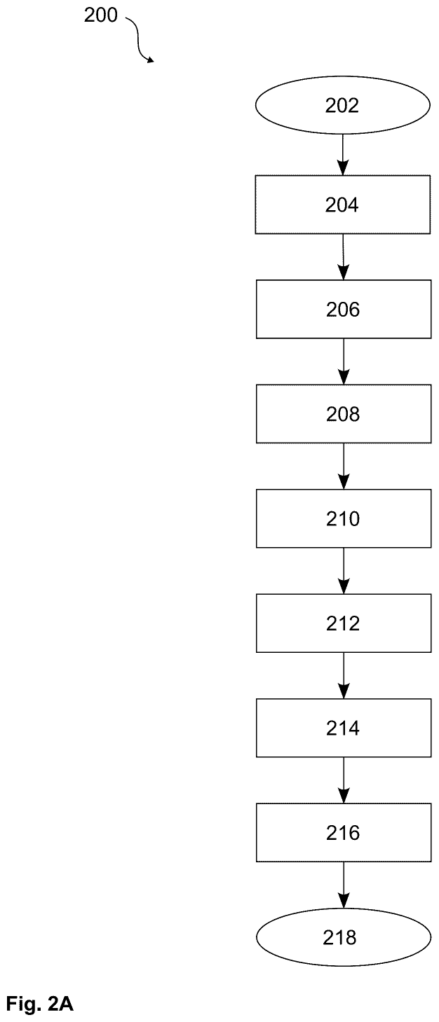

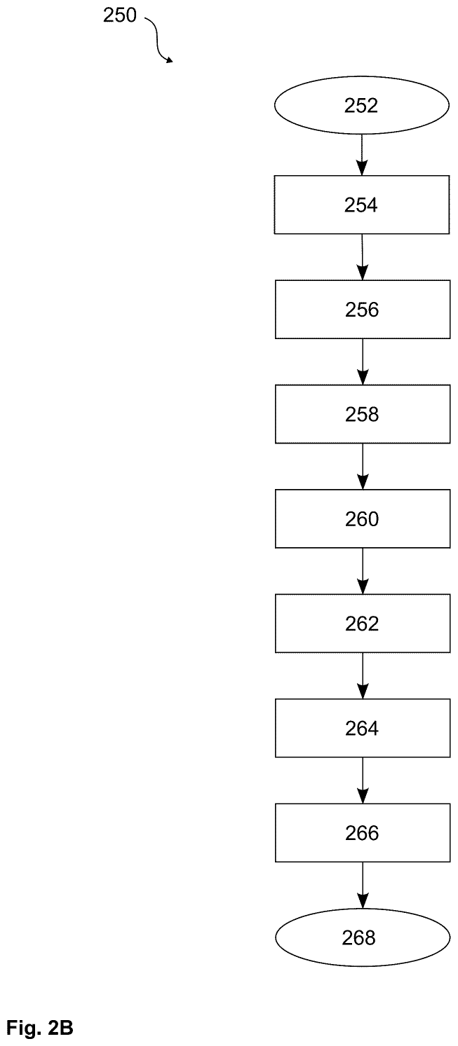

For this purpose, the backend 104 interacts with the mobile device 106 and the vehicle 102. One exemplary embodiment of a corresponding allocation method will be described in more detail below with reference to the sequences illustrated schematically in FIGS. 2A and 2B. In this case, FIG. 2A shows a sequence of a method 200 for controlling access to the motor vehicle 102 in the mobile device 106. FIG. 2B shows a sequence of a corresponding method 250 in the backend 104.

It should be noted that the method 200 from FIG. 2A may take place in the mobile device 106, but also in whole or in part in a backend for the mobile device 106; however, this will not be discussed further hereinafter for the sake of clarity. It should also be noted that any communication 116 (cf. FIG. 1) described below between the mobile device 106 and the backend 104 may for example be based on one or more mobile radio-based connections, or else also on short-range wireless connections in the case of which, for example, the vehicle 102 may serve as a relay station for forwarding the communication between the mobile device 106 and the or a backend server 104. For the sake of clarity, this will not be discussed further in the rest of the description.

A sequence may begin with preliminary registration 118 (cf. FIG. 1) of the user 108 with their mobile device 106 with a server 104. For this purpose, in step 202 in the method 200 in FIG. 2A, a registration message is transmitted from the mobile device 106 to the server 104. The device key 112 may be stored in the secure environment 110 prior to the registration process 118, or may be generated in the course of the registration process. What is essential is that the device key 112 is used in connection with the creation and sending of the registration message, for example in order to sign the registration message (step 204) and/or insert a public key portion of the device key 112 into the registration message (however, the public key portion could also reach the backend server 104 in some other way).

The corresponding sequence of the method 250 in FIG. 2A with regard to registration 118 begins in step 252 with the receipt of the registration message at the backend server 104. In response to the receipt, in step 254, the device key 112 (more specifically a public key portion of the device key 112) is stored in association with a profile of the user 108. In other words, the device key 112, which is present in the secure area 110 on the mobile device 106 of the user 108 (the derived key 114 is to be stored therein later), from the point of view of the backend server 104, binds precisely this secure environment 110 of the mobile device 106 to the user profile of the user 108 in the backend 104. These considerations also include exemplary embodiments in which the device key 112 is present in a secure environment and the shared vehicle key 114 is stored later in another, separate secure environment.

It is again pointed out that not every app has access to a secure environment of a mobile device. Only trustworthy apps that are for example trusted by a manufacturer of the mobile device 106, are registered, are certified etc. are able for example to generate the device key 112 and store it in the secure environment 110.

The actual allocation process 120 for the derived key 114 begins in step 206 in FIG. 2A, such that the user 108 asks to use the vehicle 102. More specifically, in step 206, a request message is transmitted from the mobile device 106 to the backend server 104, asking for allocation of a derived key to access the vehicle 102. In other exemplary embodiments, the allocation method 120 may instead for example be triggered in the backend 104 by a request message, for instance by virtue of a predefined booking time being reached.

Preferably, the device key 112 is used to sign the request message or part thereof, because the backend server 104 is thus able to determine whether the registered user 108 transmitted the request from their mobile device 106, as is stored in the user profile. The service in the backend 104 will ensure that the derived key 114 reaches only the mobile device 106 whose device key 112 was saved at registration 118, otherwise the backend 104 will react accordingly.

In a step 256 in the method 250, the request message from the mobile device 106 is received in the backend 104. The public key portion, stored in the backend 104, of the device key 112 is used to check the signature of the request message. In the event of a positive check, in a step 258, inter alia, the derived vehicle key 114 (a public key portion) for the vehicle 102 is stored in the mobile device 106.

In a step 208, the allocated key 114 is received in the mobile device 106 and stored in the secured environment 110. Steps 258 and 208 may in particular comprise sending and receiving a URL, respectively. Calling the URL may trigger the actual allocation process, in which for example corresponding attestation packets may also be received both in the mobile device 106 and in the vehicle 102.

If the allocated key 114 were to be already fully activated at this time, the user 108 would be able to use the allocated key 114 to open or unlock the vehicle 102, start a motor of the vehicle 102, etc. However, the exemplary embodiment of an allocation method as described here makes provision for a verification 122 that is used to verify that the allocated vehicle key 114 is actually stored together with the device key 112 in the environment 110 of the mobile device 106. For this purpose, the backend server 104 may, as part of the verification process 122, initiate a handshake procedure with the mobile device 106 from which the request process 118 was triggered.

By way of example, a two-factor authentication (2FA) procedure will also be assumed, in which the allocated key 114 is fully activated only when a second factor, for instance a character string, a PIN, etc., which is transmitted to the mobile device 106, is entered in a console on the vehicle 102. Before the PIN is entered in the vehicle 102, the allocated key 114 may for example only allow entry into the vehicle 102 so that the user 108 is able to access a console in the vehicle 102 in order to enter the PIN. However, the receipt of the PIN will be delayed until the verification process 122 has been successfully completed.

In addition or as an alternative, the allocated key 114 may be fully blocked when sent 120 and prior to verification 122, that is to say also not allow entry to the vehicle 102. Entry to the vehicle 102 may be enabled after successful verification 122, and full activation with access rights to drive the vehicle 102 takes place after the PIN has been entered on the vehicle 102.

Specifically, in the present exemplary embodiment, the backend server 104, in step 260 in FIG. 2B, transmits one-time information (a nonce), which is received in the mobile device 106 in step 210 in FIG. 2A. In step 212, the received one-time information is signed both with the device key 112 and with the assigned key 114. Next, in step 214, a verification message based on the signed one-time information is created and sent.

In step 262 in the method 250 in FIG. 2B, the backend server 104 receives the verification message and uses the signed one-time information to verify that the derived key 114 is actually stored on the mobile device 106. The verification is possible because the server 104 knows the one-time information, and also the allocated vehicle key 114 and the device key 112 for the mobile device 106 (the device key 11 has been stored in association with the profile of the user 108 since they registered 118).

The backend system 104 will terminate the derived key 114 if the verification fails. In the event of successful verification, the retained second factor (PIN) is sent. In one exemplary embodiment, the backend server may only at this time already enable access to the vehicle 102 such that the user is able to use the derived key 114 to unlock the vehicle 102, and thus has access to a vehicle console, but without being able to start a motor of the vehicle.

More specifically, the backend server 104, in step 264, performs the sending, which has been delayed up to now, of the mentioned PIN as a second authentication factor for the derived key 114 to the mobile device 106 (this is also illustrated as process 124 in FIG. 1). In step 216 in the method 200 in FIG. 2A, the mobile device 106 receives the sent PIN and displays it for example on a display on the mobile device 106. Full activation of the derived key 114 is carried out after the user 108, in a process 126, reads the displayed PIN from the mobile device 106 and, in a process 128, enters it in the vehicle 102. In a process 130, based on the entered PIN, the vehicle 102 activates the allocated vehicle key 114 and communicates the new status of the shared vehicle key 114 to the backend 104.

Following receipt of the authentication factor in step 266 in FIG. 2B and successful verification of the PIN in the vehicle 102, the status of the derived vehicle key 114 is updated in the backend 104. Finally, access takes place in step 218 in the method 200 in FIG. 2A, including starting a drive motor of the vehicle 102 by way of the allocated vehicle key 114.

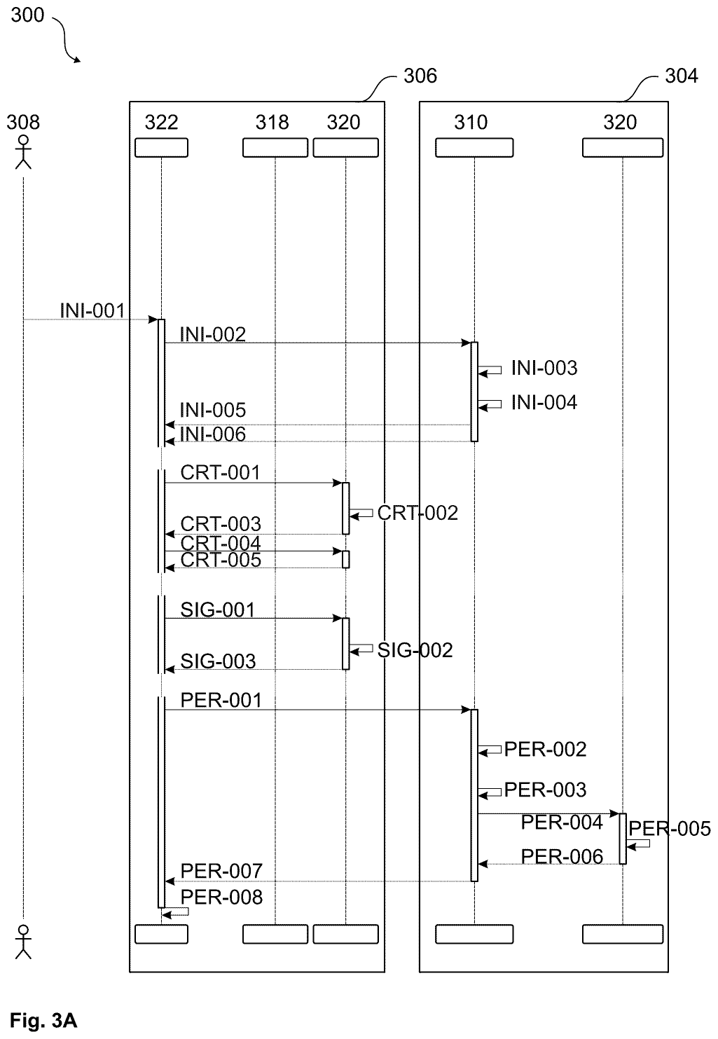

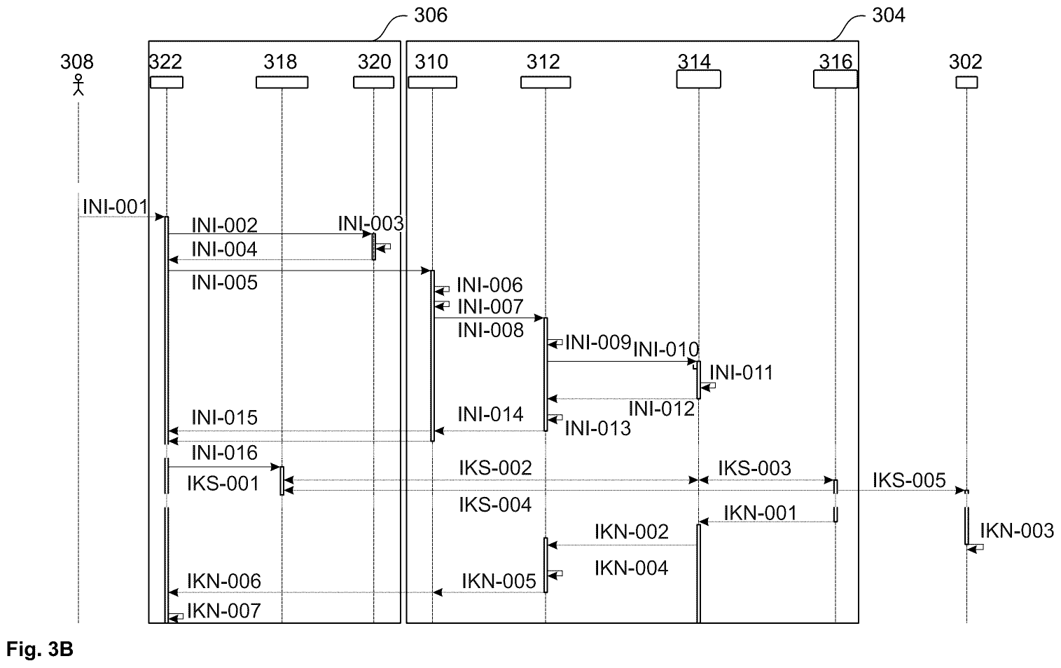

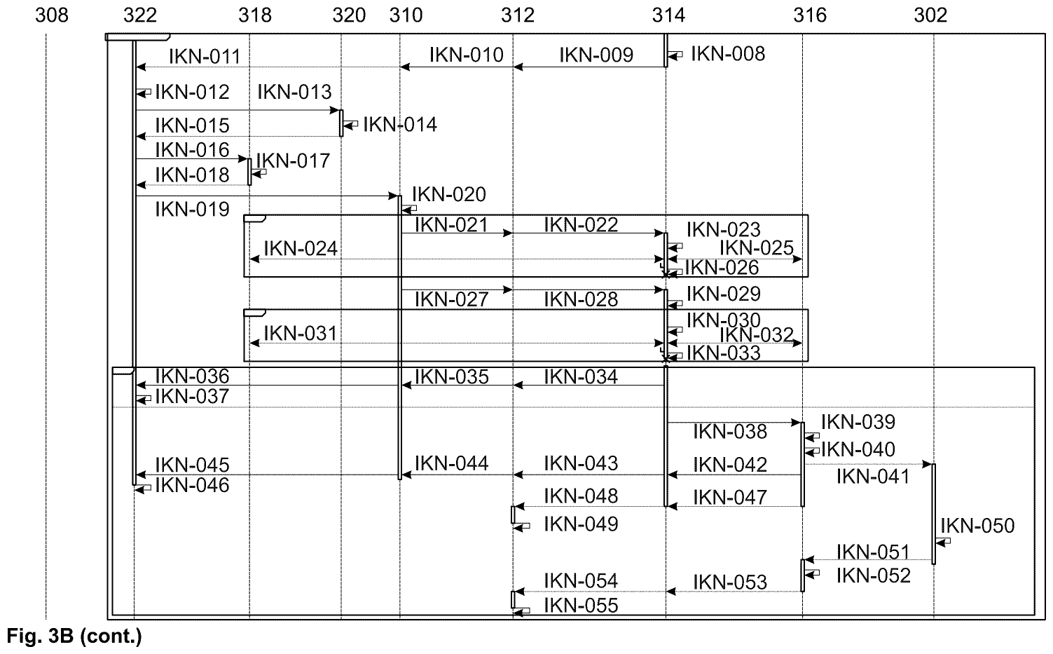

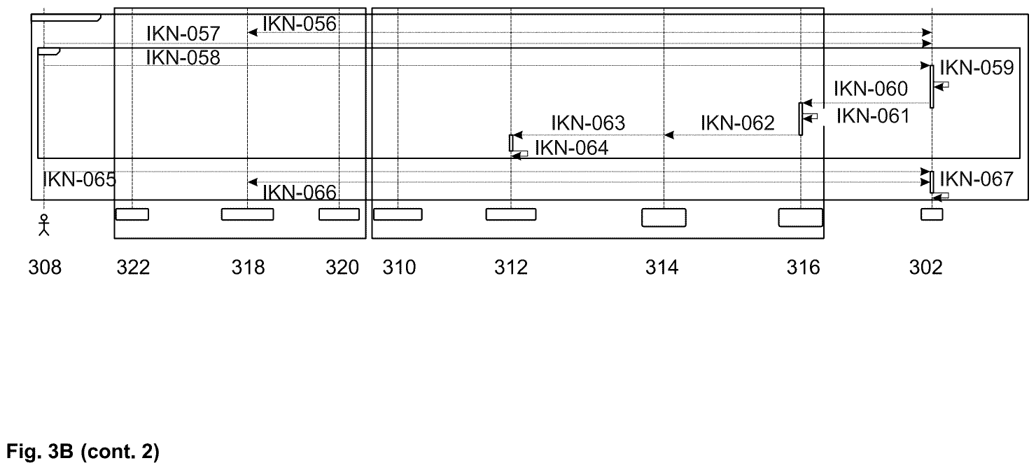

FIG. 3A illustrates, in the form of a schematic flowchart, a further exemplary embodiment of a method 300 for controlling access to a motor vehicle 302, wherein a backend 304 of the vehicle 302 and a mobile device 306 of a user 308 interact.

The backend 304 comprises a technical service server 310 and a functional service server 312 of a service provider, wherein the service may for example concern car sharing, car rental, fleet management, a valet parking service, etc. Although it will be assumed, for the sake of clarity, that the servers 310 and 312 are operated by a single service provider, the servers 310, 312 could also be operated by different service providers, providers, etc.

The mobile device 306 contains an operating system-specific secure element 318, along with a secure environment 320. A service app 322 is involved in controlling that portion of the method 300 that runs on the mobile device 306. By way of example, the app 322 may be made available by a manufacturer of the vehicle 302, the service provider 310/312, or for example a service provider for a key management entity.

The user 308 wishes to ask the service provider 310/312 to allocate (share) a vehicle key at a later time. By way of example, the user 308 would like to rent a vehicle, or park a given vehicle (that is to say the vehicle 302) as a service for the owner, driver, etc. The user 308 therefore asks the service provider 310/312 to allocate a vehicle key, for example because they have installed the app 322 of the service provider 310/312 on their mobile device 306.

It will be assumed that the app 322 used by the user 308 does not have a cryptographic key for management purposes that resides in the secure element 318. Instead, the app 322 must rely on a cryptographic key stored in the secure environment 320 of the mobile device 306. The method illustrated in FIG. 3A serves the purpose of assigning such a cryptographic key to the mobile device 306. This takes place during a registration process of the user 308 for the service provided by the service provider 310/312. The mobile device 306 is used for registration.

For the sake of clarity, it will be assumed for the method 300 that the user 308 already has a user account with the service provider 310/312. The service app 322 is logged into the user account. However, there is still no binding, or any fixed, binding assignment of the user 308, the mobile device 306, the app 322 or the secure environment 318/320. It should be noted that the method sequence 300 concerns only initial establishment of such a binding assignment. Corresponding method sequences concerning the use of the app 322 on another device of the user 308 are conceivable; a procedure when the app 322 is deleted and reinstalled (with the device key being lost); and logging in with another account on the same device 306.

According to the described method, the user 308 actively triggers the method 300 in a step INI-001. However, the method could also be called automatically when logging into the app 322 for the first time, when creating a user profile with the service provider 310/312, etc.

In a step INI-002, the app 322 transmits a request to the server 310 to initiate the method portion there. In a step INI-003, the technical service server 310 verifies the received request message and checks whether an assignment status is already present. In the case of the sequence 300 in FIG. 3A, it will be assumed that no assignment is present. In a step INI-004, the server 310 therefore creates a session, that is to say assigns a session ID, which may for example be one-time information (a nonce).

In a step INI-005, the technical service server 310 confirms the request. In a further step INI-006, the server 310 makes the app 322 on the mobile device 306 aware of the assigned session ID.

Following successful initiation of the method 300 for creating a binding assignment, a device key is then generated. For this purpose, in a step CRT-001, the app 322 triggers the secure environment 320, which then, in a step CRT-002, generates a cryptographic key 324, for example an ECC (elliptic-curve cryptography) key. In a step CRT-003, the key generation is confirmed to the app 322.

In a step CRT-004, the app 322 then requests a public key portion of the generated key, which is returned from the secure environment 320 in a step CRT-005.

In a further method section, the generated device key signs itself for use for the binding assignment. For this purpose, in a step SIG-001, the app 322 transmits a corresponding request message to the secure environment 320. By way of example, the request message may specify the session ID received from the server 310 along with the public key portion of the generated device key 324.

In a step SIG-002, the secure environment 320 signs the received data with the device key 324 and, in a step SIG-003, it returns the data signature to the app 322.

In a further method section, the actual binding assignment is then technically established or laid down. For this purpose, in a step PER-001, the app 322 transmits a corresponding request message containing assignment data to the technical service server 310. The assignment data may for example contain the public key portion of the device key 324 of the secure environment 320 along with the data signature of the secure environment 320.

In a step PER-002, the service server 310 verifies a validity of the request and checks for instance whether the session still exists, and whether the data signature of the secure environment 320 is valid. This is possible because the service server 310 possesses the session ID. In the event of positive verification or validation, in a step PER-003, the service server 310 updates the user profile of the user 308 and supplements or replaces the public key portion of the device key 324 there; this technically establishes a binding assignment of the user 308, the app 322, and the mobile device 306 with the secure environment 320.

In a step PER-004, the technical service server 310 transmits a request message to the functional service server 312 to update the user profile there. The functional service server 312 performs this in a step PER-005 and confirms this performance to the technical server 310 in a step PER-006. The technical service server 310 then confirms the changed binding status to the app 322 on the mobile device 306 in a step PER-007. In a step PER-008, the app 322 updates the binding status to “bound” or the like.

FIG. 3B illustrates, in the form of a schematic flowchart, a further exemplary embodiment of a method 350 for controlling access to the motor vehicle 302. Although not mandatory, the method 350 may adjoin the method 300 from FIG. 3A or follow it in time. For the sake of clarity, the same reference signs are therefore used for the same elements.

In addition to the technical and functional service servers 310 and 312 that have already been described, a key management functional service 314 and a key management technical service 316 (that is to say for the management of digital vehicle keys) are indicated in the backend 304. Although it will be assumed, for the sake of clarity, that the servers 314 and 316 are operated by a single provider, such as for example a manufacturer of the vehicle 302, the servers 314 and 316 may also be operated by different service providers, providers, etc.

In the scenario 300 in FIG. 3A, the user 308 has registered with the service provider 310/312. This process involved in particular storing a binding assignment of the user 308, the mobile device 306, the service app 322 and the secure environment 318/320 in the user profile of the user 308 at the service provider 310/312, that is to say signing it with a device key 324 held in the secure environment 320 of the mobile device 306. In the scenario 350 in FIG. 3B, the user 308 then asks the service provider 310/312 to allocate (share) a vehicle key; for example, they would like to rent a vehicle or to park a given vehicle (that is to say the vehicle 302) as a service provider. The user 308 therefore asks the service provider 310/312 to allocate (share) a vehicle key, for example because they have installed the app 322 of the service provider 310/312 on their mobile device 306.

According to the method 350, the user 308 has to activate a key allocated thereto by entering a PIN. This PIN is sent by the key management entity 314/316 to the user 308 only after successful verification, in which the device key 324 is used to verify that the shared key is actually stored on the authorized mobile device 306.

In addition or as an alternative, it is conceivable for the shared key to be shared in a blocked state, such that it initially grants no access rights whatsoever either to open or unlock the vehicle 302 or to start the motor of the vehicle 302. The key would be activated only after a positive verification of the authorized mobile device 306. A combination of the two abovementioned methods is outlined in detail below with reference to the sequence 350 in FIG. 3B.

The sequence 350 begins when a booking process is initiated. Specifically, in a step INI-001, the user initiates the booking process in the service app 322, which then initiates the booking process by assigning a booking ID and, in a step INI-002, provides the booking ID to the secure environment 320 for signing. In a step INI-003, the secure environment 320 signs the booking ID with the device key 324 that has been stored in the secure environment 320 since the registration process (method 300) and transmits the signature to the service app 322 in a step INI-004.

In a step INI-005, the service app 322 then transmits a corresponding booking request to the technical service server 310. In a step INI-006, the latter verifies the received signature and booking request. Following positive verification, a driver-vehicle pool assignment is assigned to the booking process in a step INI-007, and the booking process is forwarded to the functional service server 312 in a step INI-008.

In a step INI-009, the functional service server 312 checks the booking, in particular to determine whether an initiation time is within a booking time or scheduled lead time. If this is the case, in a step INI-010, an allocation URL and a designation (friendly name) for the allocated key are requested, these possibly concerning for example a user name, a profile name, etc. of the user 308.

In a step INI-011, the functional key management entity 314 then generates the allocation URL, stores it and assigns a name for the key to be allocated. The URL points, for administratively allocated or server-based keys, to a server in the backend 304, that is to say for example to a server of the key management entity 314/316. The URL is delivered to the recipient of the key to be allocated, that is to say the user 308, for example via e-mail, chat message or a push notification, and must be retrieved on the mobile device 306 on which the key to be allocated is to be stored.

It is pointed out again at this juncture that the derived key must be activated using a PIN in accordance with the method 350. The allocated key may in this case initially be allocated an “inactive” status, that is to say for example allow only entry to the vehicle 302, but not starting of a motor of vehicle 302. Only entry of a PIN in a head unit of the vehicle 302 will activate the key or set its status to “active”. In addition or as an alternative, key activation may be carried out by the backend 304, in which the key is allocated as being “blocked”, that is to say without any access rights, wherein full activation takes place following positive confirmation of receipt of the allocated key on the target device 306. A combined scenario is likewise conceivable, as described below.

Specifically, in a step INI-012, the functional key management entity 314 returns the requested allocation URL to the requesting functional service server 312. In a step INI-013, the latter updates the booking data and stores the allocation URL. In a step INI-014, the functional service server 312 delivers the allocation URL to the technical service server 310. The latter confirms the successful booking to the service app 322 in a step INI-015 and, in a step INI-016, delivers the allocation URL together with the booking ID to the service app 322.

Once the booking has been made, the mobile device 306 initiates the technical process of allocating the derived vehicle key for the vehicle 302. For this purpose, in a step IKS-001, the service app 322 calls the allocation URL, thereby launching a standardized key sharing process. Specifically, in a step IKS-002, the secure element 318 initiates a sequence flow for allocating a derived key 326 (for example “Friend Key” in accordance with the CCC), specifically in interaction with the functional key management entity 314. In step IKS-002, which may also comprise multiple steps that are not shown in detail in FIG. 3B, the allocated key 326 is stored in the mobile device 306, that is to say in the secure element 318.

As part of the key allocation, the functional key management entity 314, in step IKS-003, also initiates key tracking in interaction with the technical key management entity 316, this being illustrated only in simplified form in FIG. 3B. Furthermore, the technical key management entity 316 distributes an attestation packet to the secure element 318 (step IKS-004) and to the vehicle 302 (step IKS-005), which is likewise shown in simplified form here. In parallel with the updating of the booking status, the vehicle 302, in a step IKN-003, processes the attestation packet and stores the allocated key in a key table.

This completes the technical key allocation process, but the status of the procedure must still be communicated to all parties involved. For this purpose, in a step IKN-001, the technical key management entity 316 sends an event message to the functional key management entity 314 and communicates the status of the allocated key 326 as “inactive” (or “blocked”). In a step IKN-002, the functional key management entity 314 forwards this event message to the functional service server 312. In a step IKN-004, the latter then updates the booking status to “booking initiated” and stores information concerning the allocated key 326. In a step IKN-005, the functional service server 312 forwards the updated booking status and for example a key ID to the technical service server 310.

The technical service server 310 in turn, in a step IKN-006, forwards the updated booking status and the key ID in association with the booking ID to the service app 322 on the mobile device 306. The service app 322 updates the booking status and stores the key ID in a step IKN-007.

In some exemplary embodiments, a PIN could be transmitted directly to the mobile device 306 following booking and key allocation by the key management entity 314/316, said PIN having to be entered on the vehicle 302 in order to activate the allocated key 326. In addition or as an alternative, it could be necessary to activate the key 326 from the backend 304, for example following a call from the user 308 using the mobile device 306 to the service provider 310/312 or the key management entity 314/316. In the method 350 in FIG. 3B, however, activation of the key 326 is preceded by a verification, and the sending of the PIN to the mobile device 306 is also delayed until successful verification has been performed. The verification ensures that the allocated key 326 is actually located on the mobile device 306 of the authorized user 308, in accordance with the binding assignment based on the device key 324, which assignment has been stored in the profile of the user 308 at the service provider 310/312 since registration (for example in accordance with the method 300 from FIG. 3A).

The verification procedure is launched by the functional key management entity 314 in a step IKN-008 with the generation of one-time information (a nonce). In a step IKN-009, the one-time information is forwarded to the functional service server 312. The latter forwards the one-time information, in a step IKN-0010, to the technical service server 310, which in turn, in a step IKN-011, forwards a request message containing the one-time information to the service app 322 on the mobile device 306.

The service app 322 then, in a step IKN-012, compiles data to be signed, containing the allocation URL and the received one-time information. In a step IKN-013, the service app 322 requests a signature from the secure environment 320. The secure environment 320 then signs the data, in a step IKN-014, with the device key 324 stored in the secure environment 320 and returns the signature to the service app 322 in a step IKN-015.

In a step IKN-016, the service app 322 requests a signature from the secure element 318, for example a signature of the compiled data and/or a signature of the data that have already been signed with the device key 324. The secure element 318 then, in a step IKN-017, creates and signs the requested one or more signatures by way of the allocated vehicle key 326 stored there and returns the result to the service app 322 in a step IKN-018.

In a step IKN-019, the service app 322 transmits the one-time information signed with the device key 324 and the allocated key 326 to the technical service server 310. In a step IKN-020, the latter verifies the signature concerning the device key 324.

If this verification fails, for instance because the allocated key 326 is stored on a mobile device other than the mobile device 306 (this is bound to the authorized user 308 by the device key 324), in an optional step IKN-021, the technical service server 310 transmits a corresponding message “wrong target device” or the like to the functional service server 312. In a step IKN-022, the functional service server 312 forwards this message to the functional key management entity 314. In a step IKN-023, the latter annuls the allocated key 326 and terminates respective portions of the allocated key 326 in interaction with the secure element 318 on the mobile device 306 (step IKN-024) and with the technical key management entity 316 (step IKN-025).

In the event of positive verification, the technical service server 310, in a step IKN-027, forwards the data received from the service app 322 (in a step IKN-019) in a step IKN-027 to the functional service server 312, which forwards them to the functional key management entity 314 in a step IKN-028. The latter (and/or the technical key management entity 316) verifies the signature created with the allocated key 326.

In the event of discrepancies here, in an optional step IKN-030, the key management entity 316 annuls the allocated key 326 and terminates respective portions of the allocated key 326 there in interaction with the secure element 318 on the mobile device 306 (step IKN-031) and with the technical key management entity 316 (step IKN-032).

As already mentioned, in the event of positive verification in steps IKN-020 and IKN-029, a 2FA may be used, in which for example a PIN is used as the second factor. In the exemplary embodiment illustrated in FIG. 3B, the functional key management entity 314, in a step IKN-034, transmits a reference to the successful verification and an activation PIN to the functional service server 312, which, in a step IKN-035, forwards it to the technical service server 310, and this in turn, in a step IKN-036, forwards it to the service app 322 on the mobile device 306. In a step IKN-037, the service app 322 outputs the received PIN on a display of the mobile device 306.

In another exemplary embodiment, in the event of positive verification in steps IKN-020 and IKN-029, the allocated key 326 could be activated from the backend 304. A combination of these two exemplary embodiments is also conceivable, in which the allocated key 326 is initially blocked starting from the allocation in step IKS-002 (and this status is communicated as such in step IKN-001). However, as described, a PIN may be transmitted to the mobile device 306. At the same time, the key, which has been blocked up to now, may be activated automatically in the event of successful verification such that it now allows entry to the vehicle 302 (but not yet starting of the motor).

Specifically, the functional key management entity 316 may, in a step IKN-038, transmit a request to the technical key management entity 316 to lift the block on the allocated key 326. The technical key management entity verifies the request in a step IKN-039, updates the status of the allocated key 326 to “not blocked” or the like in a step IKN-040, and, in a step IKN-042, provides feedback to the functional key management entity 314 that the status of the allocated key has been successfully changed. The functional key management entity 314 forwards the feedback, in a step IKN-043, to the functional service server 312, which forwards the feedback, in a step IKN-044, to the technical service server 310. This in turn forwards the feedback to the service app 322 on the mobile device 306 in a step IKN-045. The service app 322 outputs the status of the allocated vehicle key as “enablement pending” or the like on a display of the mobile device 306 in a step IKN-046.

In parallel therewith, the technical key management entity 316 may, in a step IKN-047, send an event message to the functional key management entity 314 that the status of the allocated key 326 has changed to “clearance pending” or the like. In a step IKN-048, the functional key management entity 314 then forwards an event message to the functional service server 312 that the status of the allocated key 326 with regard to the issued URL has changed to “enablement pending” or the like. In a step IKN-049, the functional service server 312 updates the booking status to “key enablement pending” or the like.

Following successful verification, the attestation packet may additionally be transferred, in a step IKN-056, from the secure element 318 to the vehicle 302, if the vehicle 302 was offline in step IKS-005. More specifically, the vehicle must, in accordance with the CCC in the case of the option “blocked key”, be parked in a defined area with mobile phone reception; the CCC does not provide any other alternatives, that is to say no offline path is provided. For a key update option (role, rights, etc. for which an update such as for instance an “update attestation” is required), there may therefore be only a proprietary channel available between the vehicle OEM and the vehicle.

If 2FA is not used, the technical key management entity 316, following successful verification, may also trigger activation of the allocated vehicle key 326 directly, as shown in step IKN-041. In a step IKN-050, the vehicle 302 then updates the status of the allocated key 326 to “active” or the like, such that, from this time on, it is possible to drive the vehicle 302. In a step IKN-051, the vehicle 302 also provides confirmation of processing to the technical key management entity 316 in the backend 304. In a step IKN-052, the technical key management entity 316 updates the key status in the backend 304 accordingly.

In a step IKN-053, the technical key management entity 316 transmits an event message concerning a change in the status of the allocated key 326 to “active” or the like to the functional key management entity 314. In a step IKN-054, the latter sends an event message concerning a change in the status of the allocated key 326 to “active” or the like for the issued URL to the functional service server 312. The latter then, in a step IKN-055, changes the booking status to “active” or the like.

Referring again to the part of the sequence flow in FIG. 3B concerning the use of 2FA, the PIN for activating the allocated key is displayed on the mobile device 306 in step IKN-037. In a step IKN-057, it is assumed that the user 308 enters the vehicle 302, because the allocated key 324 grants this access right, either already since the allocation in step IKS-002 or following successful verification of the binding assignment of the device key 324 and the allocated key 326, that is to say for example in step IKN-046.

In a step IKN-058, the user 308 enters the PIN displayed on the mobile device 306 into the vehicle 302. In a step IKN-059, the vehicle 302 then updates the status of the allocated key 326 to “active” or the like, such that, from this time on, it is possible to drive the vehicle 302. In a step IKN-060, the vehicle 302 also provides confirmation of processing to the technical key management entity 316 in the backend 304. In a step IKN-061, the technical key management entity 316 updates the key status in the backend 304 accordingly.

In a step IKN-062, the technical key management entity 316 transmits an event message concerning a change in the status of the allocated key 326 to “active” or the like to the functional key management entity 314. In a step IKN-063, the latter sends an event message concerning a change in the status of the allocated key 326 to “active” or the like for the issued URL to the functional service server 312. The latter then, in a step IKN-064, changes the booking status to “active” or the like.

In a step IKN-065, the user or driver 308 may issue a command to start a drive motor of the vehicle 302. In a step IKN-066, transactions may take place between the secure element 318 and the vehicle 302, concerning for example an exchange of demobilization tokens. In a step IKN-067, the vehicle 302 starts the motor.

Exemplary embodiments of the invention may ensure that a derived or allocated vehicle key (based on a digital vehicle key) is activated only if it is stored on an authorized mobile device. More specifically, it may be ensured that the allocated key is stored only on a mobile device of the authorized user that is known to a service provider by virtue of being registered or the like.

Exemplary embodiments of the invention may thus prevent misuse that may arise whereby a key allocation URL is forwarded from a mobile device for which it is intended to another device without authorization. This increases trust in server-based or administrative digital key allocation procedures, as are advantageous for vehicle rental, car sharing, fleet management, etc., but also valet parking services, etc. Exemplary embodiments of the invention may thus promote the dissemination of corresponding business models, which in turn enable efficient vehicle use. Exemplary embodiments of the invention generally increase the practicality and security of digital vehicle keys.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 System
102 Motor vehicle
104 Backend server
106 Mobile device
108 User
110 Secure environment
112 Cryptographic device key
114 Derived/shared/allocated key
116 Communication between mobile device 106 and backend 104
118 Registration process
120 Allocation process for the derived key 114
122 Verification process
124 Send the 2FA PIN
126 Display PIN on the mobile device 106
128 Enter the PIN in the vehicle 102
130 Forward the PIN to the backend 104
200 Method
202 Start of the method: Registration
204 Sign the registration message
206 Send a request message
208 Receive the allocated key
210 Receive one-time information
212 Sign the one-time information
214 Create and send a verification message
216 Receive a PIN
218 End of the method: Start the motor
250 Method
252 Start of the method: Receive the registration message
254 Store the device key
256 Receive the request message
258 Transmit the allocated key
260 Transmit the one-time information
262 Receive the verification message
264 Transmit the PIN
266 End of the method: Receive an indication regarding the PIN
300 Method
302 Motor vehicle
304 Backend
306 Mobile device
308 User
310 Technical server service provider
312 Functional server service provider
314 Functional key management entity
316 Technical key management entity
318 Secure element
320 Secure environment
322 Service app
324 Device key
326 Derived/shared/allocated key
INI-001-INI-006 Initiate the registration method 300
CRT-001-CRT-005 Create the device key 324
SIG-001-SIG-003 Sign registration data
PER-001-PER-008 Registration method 300 in the backend 304
350 Method
INI-001-INI-016 Booking process
IKS-001-IKS-005 Allocate the derived key 326
IKN-001-IKN-007 Distribute the status of the allocated key 326
IKN-011-IKN-033 Verification
IKN-034-IKN-037 Deliver the activation PIN
IKN-038-IKN-055 Activation in the backend 304
IKN-056-IKN-067 PIN entry and activation in the vehicle 302

What is claimed is:

1. A method for controlling access to a motor vehicle, comprising:
receiving a shared vehicle key for a user of the motor vehicle, wherein the shared vehicle key is derived from a digital vehicle key for the motor vehicle;
transmitting a verification message to verify that the shared vehicle key is stored on a mobile device of the user;
following transmission of the verification message, receiving an authentication factor for activation of the shared vehicle key; and
accessing the motor vehicle by way of the shared vehicle key.

2. The method according to claim 1, further comprising:
creating the verification message based on a device key stored securely in the mobile device.

3. The method according to claim 2, further comprising a preliminary step of transmitting a registration message based on the device key.

4. The method according to claim 3, further comprising:
signing a request message with the device key; and
transmitting the request message to request the shared key.

5. The method according to claim 1, wherein access rights of the shared vehicle key prior to receiving the authentication factor comprise access to the motor vehicle, but not driving the motor vehicle.

6. The method according to claim 1, wherein the authentication factor of a multi-factor authentication comprises a character string to be entered in the motor vehicle.

7. The method according to claim 1, wherein the shared vehicle key, without verification, does not comprise any access rights to the motor vehicle.

8. The method according to claim 2, further comprising:
receiving one-time information;
signing the one-time information with the shared vehicle key and the device key; and
creating the verification message based on the signed one-time information.

9. A method for controlling access to a motor vehicle, comprising:
transmitting a shared vehicle key for a user of the motor vehicle, wherein the shared vehicle key is derived from a digital vehicle key for the motor vehicle;
receiving a verification message to verify that the shared vehicle key is stored on a mobile device of the user;
in response to receiving the verification message, transmitting an authentication factor; and
receiving an indication that the shared vehicle key has been activated based on entry of the authentication factor.

10. The method according to claim 9, comprising preliminary steps of:
receiving a registration message based on a device key stored securely in the mobile device; and
storing the device key in association with a profile of the user.

11. The method according to claim 9, wherein the verification is carried out based on the stored device key.

12. The method according to claim 11, wherein the shared vehicle key is terminated if the verification fails.

13. A mobile device, designed to control access to a motor vehicle in accordance with a method according to claim 1.

14. A backend server, designed to control access to a motor vehicle in accordance with a method according to one of claim 9.

15. A system for controlling access to a motor vehicle, comprising:
the motor vehicle;
a mobile device configured to control access to a motor vehicle in accordance with a method comprising:
receiving a shared vehicle key for a user of the motor vehicle, wherein the shared vehicle key is derived from a digital vehicle key for the motor vehicle;
transmitting a verification message to verify that the shared vehicle key is stored on a mobile device of the user;
following transmission of the verification message, receiving an authentication factor for activation of the shared vehicle key; and
accessing the motor vehicle by way of the shared vehicle key; and
a backend server configured to control access to the motor vehicle in accordance with a method comprising:
transmitting a shared vehicle key for a user of the motor vehicle, wherein the shared vehicle key is derived from a digital vehicle key for the motor vehicle;
receiving a verification message to verify that the shared vehicle key is stored on a mobile device of the user;
in response to receiving the verification message, transmitting an authentication factor; and
receiving an indication that the shared vehicle key has been activated based on entry of the authentication factor.
